(19) United States
(12) Patent Application Publication
(10) Pub. No.: US 2006/0292062 A1
(43) Pub. Date: Dec. 28, 2006

(54) Metal oxide materials, production method thereof, and application thereof

(76) Inventors: Fusao Hojo, Naka (JP); Shinji Yamada, Tsukuba (JP); Jiro Ushio, Hachioji (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/473,086

(22) Filed: Jun. 23, 2006

(30) Foreign Application Priority Data
Jun. 24, 2005 (JP) 2005-185386

(51) Int. Cl. C01G 19/02

(52) U.S. Cl. 423/594.9

(57) ABSTRACT

A mesoporous metal oxide crystal material is provided. This material has realized a large specific surface area by controlling crystallite diameter in the formation of metal oxide crystals, and preventing collapse of the mesoporous structure associated with the crystal growth upon calcinations, to improve sensitivity and effectiveness of a gas detector element of the metal oxide material and photocatalyst. A metal oxide precursor is filled in the pores of a mesoporous template, and the resulting mesoporous silica having the metal oxide precursor filled therein is added to a hydrolytic aqueous solution to thereby promote hydrolysis of the metal oxide precursor in the interior of the pores and produce a large number of metal oxide crystals in the interior of the pores. Next, the metal oxide fine crystals are heated at 300° C. or higher for calcination with the crystallite diameter controlled in the range of 1 nm to 2 nm. The part of the temperate is subsequently dissolved by an aqueous solution of NaOH or HF to leave a metal oxide material having a mesoporous structure with the crystallite diameter of not 1 nm to 2 nm.

### CLAIM OF PRIORITY

The present application claims priority from Japanese application Serial No. 2005-185386, filed on Jun. 24, 2005, the content of which is hereby incorporated by reference into this application.

### FIELD OF THE INVENTION

This invention relates to metal oxide particles or mesoporous metal oxide particles as well as their production method and application. The metal oxide particles or the mesoporous metal oxide particles of the present invention can be used for a gas sensor, a photocatalyst or various other catalysts, and the like.

### BACKGROUND OF THE INVENTION

Metal oxide crystals are often used as a catalyst, and among such metal oxide crystals, metal oxide semiconductors are used for the gas detector element of a gas sensor as well as photocatalyst. Reaction on the crystal surface is important in such applications, and crystals with a smaller size having a larger surface area in relation to the total volume of the metal oxide are advantageous, and such small crystals are expected to contribute for the improvement in sensitivity of the gas detector element as well as activity of the catalysts and photocatalysts. In addition, increase in the specific surface area by using porous metal oxide instead of simply using the aggregates of the metal oxide is effective in effectively using the metal oxide surface, and hence, in reducing the temperature range and increasing sensitivity of the gas detector element and increasing activity of the catalysts and photocatalysts.

One method for increasing the surface area of the metal oxide is reduction of the particle diameter of the constituent metal oxide crystals, and the particle diameter is preferably reduced by reducing the diameter of the crystallite constituting the particle. When the metal oxide particles are produced by hydrolytic condensation, the diameter of the crystallite generated can be controlled by choosing an adequate concentration of the precursor and an adequate reaction temperature. However, there remains the problem that the crystallite diameter is increased by the crystal growth during the calcination. The crystallite diameter of the resulting crystals can also be controlled by adjusting pH of the reaction system by adding a base or an acid to the reaction system. This method is also associated with the problem of the increase of the crystallite diameter in the subsequent calcination. It is also known that growth of the crystal during crystallization of the metal oxide by calcination can be suppressed by adding a metal ion, boric acid, or phosphoric acid. In this case, sensitivity of the resulting sensor is known to increase with the decrease in the crystallite diameter (see, for example, Non-patent Document 1 and Non-patent Document 2). However, in the case of such addition of the metal or the salt, the metal or the salt added is left as an impurity, and this leads to the difficulty of controlling the crystallite diameter of the oxide crystal to the range of not less than 1 nm and not more than 2 nm after the calcination at a high temperature. In view of such situation, a method has been developed in order to suppress the crystal growth without adding an impurity, namely, a substance other than the those generated by the reaction of producing the metal oxide by hydrolysis, and in this method, the crystal growth is suppressed by adding ammonium chloride to the metal oxide precursor (see, for example, Patent Document 1). However, even by such addition of ammonium chloride, it has been difficult to control the crystallite diameter of the resulting metal oxide crystals to the range of not less than 1 nm and not more than 2 nm.

In addition, even if the crystallite diameter were reduced, the resulting metal oxide crystals have been particles generated by the aggregation of a large number of crystals, and the specific surface area of the resulting particle has been smaller than the specific surface area expected from the crystallite diameter. In view of such situation, an alternative method of increasing the surface area of the metal oxide has been proposed in which the material used has a porous structure. Use of a porous material having smaller and regular pores allows production of a material having an increased surface area. For example, mesoporous silica having a regular mesoporous structure is known to have an extremely high specific surface area. Mesoporous materials are produced by using the phenomenon that a regular mesoporous structure is formed by an antistatic action, hydrogen bond, covalent bonding, and van der Waals interaction between a surfactant and a silica precursor. Similar methods are also used in the production of a metal oxide having a crystal structure other than silica. However, formation of a metal oxides having a crystalline structure is difficult since the metal oxide having a porous structure is likely to experience collapse of the porous structure by the crystal growth during the heating of the calcination (see, for example, Non-patent Document 3). In view of such situation, a method has been developed in which a filler which does not change its shape by the calcination at a high temperature is filled in the mesopores to suppress the crystal growth of the metal oxide (see, for example, Patent Document 2). However, while this method is capable of suppressing the size of the metal oxide crystals to a size smaller than or equal to the pore diameter, the metal oxide crystals grow to the size of the pore diameter, and it is still difficult to control the crystallite diameter to the range of 1 to 2 nm. If a template having a pore diameter of 1 to 2 nm is used to suppress the crystallite diameter of the resulting crystals to the range of 1 to 2 nm, the crystallite diameter may be suppressed to the range of 1 to 2 nm. The crystal growth, however, still occurs in the calcination after removing the template, and the control of the crystallite diameter of the metal oxide to the range of 1 to 2 nm is still difficult. In addition, the metal oxide crystals having the crystallite grown to the diameter of the pore diameter are insufficient in the physical strength of the nanoporous structure, and the metal oxide crystals may experience collapse of the porous structure in the subsequent processing and molding to result in the reduced specific surface area.

[Patent Document 1] Japanese Patent Application Laid-Open No. 8-178882

[Patent Document 2] Japanese Patent Application Laid-Open No. 2003-321211

[Non-patent Document 1] Journal of Material Science Letters, 8, 1092, (1989)

[Non-patent Document 2] Chemistry Letters, 441, (1990)

[Non-patent Document 3] Langmuir, 14, 2579, (1998)

### SUMMARY OF THE INVENTION

An object of the present invention is to control crystallite diameter in the formation of metal oxide crystals, and suppress crystal growth in the calcination, and by suppressing the crystal growth, prevent collapse of the mesoporous structure associated with the crystal growth to thereby provide a mesoporous metal oxide crystal material having a large specific surface area.

The inventors of the present invention made an intensive study on the method for producing metal oxide particles, and the present invention is based on such investigation.

The characteristic features of the present invention are the formation of mesoporous metal oxide particles or metal oxide particles from metal oxide crystals having an average crystallite size of not less than 1 nm and not more than 2 nm and a crystallite diameter change rate of not more than 10% when the particles are heated at 700° C. for 3 hours. The present invention also provides construction of a gas detector element, a photocatalyst, and the like from such mesoporous metal oxide particles comprising the metal oxide crystals.

### BRIEF DESCRIPTION OF THE DRAWINGS

FIG. 1 is a cross-sectional view of the gas detector element according to an embodiment of the present invention.

FIG. 2 is a graph showing sensitivity of the gas detector elements produced in Example 3 and Comparative Example 6.

FIG. 3 is a graph showing sensitivity of the gas detector elements produced in Example 4 and Comparative Example 7.

FIG. 4 is a cross-sectional view of the gas detector element according to another embodiment of the present invention.

FIG. 5 is a graph showing sensitivity of the gas detector element produced in Example 5.

FIG. 6 is a graph showing sensitivity of the gas detector element produced in Example 6.

FIG. 7 is an exterior view of the hydrogen supplier.

FIGS. 8A and 8B are schematic views of the interior of the hydrogen supplier.

FIG. 9 is a schematic cross-sectional view of the hydrogen supplier according to another embodiment of the invention.

### DETAILED DESCRIPTION OF THE PREFERRED EMBODIMENT

The metal oxide crystals particles and the mesoporous metal oxide crystal material of the present invention have a smaller crystallite diameter and larger specific surface area compared to those of the conventional material. Accordingly, when such material is used for a gas detector element, the detector can be used at a lower temperature with a higher sensitivity compared to conventional products. When such material is used as a catalyst or a photocatalyst, the catalyst will have an improved activity.

In addition, since crystal growth at high temperature is suppressed in the metal oxide crystals and the mesoporous metal oxide crystal material of the present invention, the gas detector element, the catalyst, and the photocatalyst will have an improved thermal stability. Furthermore, since the mesoporous metal oxide particles of the present invention are constituted from crystals having a smaller crystallite diameter compared to the conventional material, the mesoporous structure will have an improved physical strength compared to the mesoporous material comprising the metal oxide crystals having a crystallite diameter in excess of 2 nm.

More specifically, the present invention relates to production of metal oxide crystals by filling a water-containing solution containing a metal oxide precursor at a high concentration in the pores of a mesoporous template, promoting hydrolytic condensation in the nanospace by using a solution containing a base at a high concentration to thereby form a large number of metal oxide fine crystals in the pore and obtain metal oxide crystals. If desired, the metal oxide fine crystals are heated for calcination with the crystallite diameter finally controlled in the nanospace in the range of not less than 1 nm and not more than 2 nm.

The part of the temperate is subsequently dissolved by an aqueous solution of NaOH or HF to leave a metal oxide material having a mesoporous structure with the crystallite diameter of not less than 1 nm and not more than 2 nm. The resulting metal oxide crystals have a crystallite diameter with an average crystallite diameter of not less than 1 nm and not more than 2 nm, and a crystallite diameter change rate of not more than 10% when the particles are heated at 700° C. for 3 hours. Such control of the crystallite diameter to the range of not less than 1 nm and not more than 2 nm and the crystallite diameter change rate to the range of not more than 10% when the particles are heated at 700° C. for 3 hours is realized by the rapid hydrolytic condensation of the metal oxide precursor solution at a high concentration in the nanospace by the hydrolysis solution at a high concentration.

More specifically, rapid reaction between the metal oxide precursor at a high concentration and a hydrolysis solution at a high concentration, and inhibition of the crystallization by the halide ion formed by the reaction enabled the formation of the metal oxide crystals having a crystallite diameter of not less than 1 nm and not more than 2 nm. Such prevention of the increase in the crystallite diameter by the calcination has been enabled for the first time by the reaction under the conditions of the present invention. Since crystal growth by the calcination is suppressed, prevention of the collapse of the mesoporous structure in the calcination has been enabled, thereby enabling the production of the mesoporous metal oxide crystals having a larger specific surface area. In addition, since the crystallites forming the nanoporous structure have a diameter smaller than conventional crystallites, and a large number of oxide crystals are assembled to form the nanoporous structure, physical strength of the nanoporous structure has been improved, with the decrease of the specific surface area prevented in the subsequent working and shaping steps.

The crystallite diameter can be controlled by the pore diameter of the mesoporous template and the concentration of the aqueous solution used for the hydrolysis. However, when the crystallite diameter is in excess of 2 nm, improvement in the efficiency of the gas detector element, the photocatalyst, or the like becomes difficult. When the crystallite diameter is less than 1 nm, the electric resistance will be unduly high rendering the measurement of the change of the resistance in the gas detection difficult.

The crystallite diameter is the average value calculated by Scherrer equation from diffraction angle and half value of the diffraction peaks of the faces of the metal oxide in powder X-ray diffraction analysis of the mesoporous metal oxide material.

The mesoporous particles are porous particles having an average pore diameter wherein peak of the pore diameter distribution curve is in the range of 1 nm to 50 nm. The pore diameter distribution curve can be depicted by a calculation method such as Dollimore-Heal method and BJH (Barrett, Joyner and Halenda) method.

The crystallite diameter change rate may be determined by the following equation (1):
The crystallite diameter change rate={(the crystallite diameter after calcination−the crystallite diameter before calcination)/(the crystallite diameter before calcination)}×100 (1)

The solution of the metal oxide precursor used in the present invention is a solution comprising the metal oxide precursor, water, and a solvent capable of dissolving the metal oxide precursor and the water.

The metal oxide precursor is a metal halide, and the metal halide is not particularly limited as long as it reacts with hydroxyl group to form a metal-oxygen bond. Exemplary halides which may be used include fluoride, chloride, and bromide, and the metal oxide crystals formed may be any metal oxide which is formed by the hydrolytic condensation. Exemplary metal oxides include an oxide containing at least one of Ba, Sr, Ca, La, Ti, Ta, Zr, Cu, Fe, W, Co, Mg, Zn, Ni, Nb, Pb, Li, K, Sn, Al, Sm, and other metals.

The solvent that may be used for the solution of the metal oxide precursor in the present invention may be any solvent which can dissolve the metal oxide precursor and the water, and exemplary such solvents include water and alcohols such as methanol and ethanol. Concentration of the water in the metal oxide precursor solution is not particularly limited as long as it is sufficient for hydrolytic condensation of the metal oxide precursor. The concentration in terms of molar concentration, however, is preferably in the range of 5 to 20 times the molar concentration of the metal oxide precursor. Concentration of the metal oxide precursor in the solution is the concentration that allows impregnation of the solution into the pores of the mesoporous template, and as long as the impregnation is possible, a higher concentration is desirable.

In the present invention, the solution used for the hydrolysis is not particularly limited as long as it contains a base that promote hydrolysis of the metal oxide precursor. The solution may be, for example, a solution prepared by dissolving water in tetrahydrofran, methanol, ethanol, or the like. Exemplary bases include ammonia, monoethanolamine, diethanol amine, triethanol amine, diethylamine, and triethylamine; as well as bicyclo cyclic amine such as DBU (diazabicycloundecene-1), DBN (diazabicyclononene). Ammonia, phosphine, an alkali metal alkoxide, ammonium hydroxide, tetramethylammonium hydroxide, benzyl trimethylammonium hydroxide, phosphine, and the like may also be used.

Concentration of the base may vary depending on the reactivity of the base. However, the concentration in the case of ammonia is preferably at least 5% by weight since use of ammonia at a concentration up to 5% by weight may induce formation of the particle having an average crystallite size in excess of 2 nm, and improvement in the sensitivity and efficiency of the gas detector element, photocatalyst, and the like is not sufficiently realized.

The mesoporous template material which can be used in the formation of the mesoporous metal oxide of the present invention is preferably a material which is capable of retaining its amorphous state with no crystal growth during the heating in the crystallization of the metal oxide, which dissolves in NaOH or HF, and which has the peak in the pore diameter distribution curve as measured by BJH method at 1 nm to 50 nm. Preferably, the mesoporous template material is a silica material which has a specific surface area of 100 to 1200 m²/g, and more preferably, a silica material whose regular mesoporous structure can be observed by X-ray diffraction analysis.

When the peak of the pore diameter distribution curve is at 500 nm or higher, the merit of the hydrolytic condensation in the nano-space is not sufficiently realized, and the resulting particles will have an average crystallite size in excess of 2 nm detracting from the merits of the improved sensitivity and improved efficiency of the gas detector element, photocatalyst, and the like. A mesoporous metal oxide material having an extremely large specific surface area can be produced by calcining the material for crystal growth after the hydrolytic condensation, and selectively dissolving the part of the mesoporous template with NaOH or HF without dissolving the part of the metal oxide crystals to thereby suppress the aggregation of the metal oxide crystals.

The metal oxide crystals and the mesoporous metal oxide material of the present invention can be used as a semiconductor gas detector element. The term “gas detector element” used herein is one having a gas detecting section comprising a membrane of a metal oxide material whose electric resistance varies by the presence or concentration of the gas to be detected. For example, a gas detector element may be constituted by forming a membrane of the mesoporous metal oxide material of the present invention on an insulated substrate such as a ceramic substrate, and embedding counter electrodes, and optionally, a heater in or under the membrane. Alternatively, a gas detector element may be constituted by forming counter electrodes on an insulated substrate such as a ceramic substrate, depositing a membrane formed from the mesoporous metal oxide material of the present invention thereon, and embedding a heater or the like in or under the membrane.

The metal oxides which may be used in the semiconductor gas detector element of the present invention include TiO₂, Fe₂O₃, Cu₂O, CuO, Cr₂O₃, Co₂O₃, NiO, In₂O₃, WO₃, ZnO, PbO, V₂O₅, KTaO₃, Bi₂O₃, SnO₂, ZrO₂, and Nb₂O₃. The gas detector element of the present invention may also be produced by using a complex metal oxide such as SrTiO₃, BaTiO₃, CaTiO₃, or Fe₂TiO₃.

In the present invention, gas detector of the gas detector element formed from a membrane of the metal oxide material is produced by dispersing the mesoporous metal oxide particles in a solvent, coating the dispersion to form the membrane, and drying and calcining the membrane. The coating may be accomplished by various methods adequately selected depending on the nature of the sol from bar coating, dip coating, roll coating, spin coating, and the like. The substrate is not particularly limited as long as it is sufficiently heat resistant to endure the calcination and gas detecting temperatures. The drying is conducted at 50 to 200° C., and the subsequent calcination is conducted at 300 to 500° C. for about 30 minutes to 2 hours, while the gas detector element can still be produced without such calcination. Increase in the crystallite diameter can be suppressed by conducing the calcination at a higher temperature.

When the metal oxide membrane is desired to have an increased strength, the membrane is preferably formed by filling the pores of the mesoporous template with the metal oxide precursor, forming a membrane of the particles having the metal oxide precursor filled therein by coating, immersing the thus formed membrane in an aqueous solution for hydrolysis to promote the hydrolysis of the metal oxide precursor in the pores to thereby form a number of metal oxide crystals in the pore. As in the embodiment as described above, the coating can be accomplished in this embodiment by various method, and the substrate is not particularly limited. Preferable temperature for the drying and preferable temperature and time for the subsequent calcination are also the same as the embodiment as described above, and a gas detector element can still be produced without conducting the calcination. Increase in the crystallite diameter can be suppressed by conducing the calcination at a higher temperature. In addition, a metal oxide membrane having a mesoporous structure comprising the metal oxide having a crystallite diameter of up to 2 nm can also be produced by gas detector element dissolving the membrane with an aqueous solution of NaOH or HF.

In the present invention, the gas detector of the gas detector element comprising the membrane of the metal oxide material may also be produced by forming a compact of metal oxide crystals or mesoporous metal oxide material. The term “compact” as used herein designates a pellet formed by filling the metal oxide material in a pressure-resistant container and applying pressure from both upper and lower sides. The semiconductor gas detector element may be constituted by forming counter electrodes on the upper side of the compact, and embedding a heater and the like on the lower side or in the compact.

### EXAMPLE 1

(Formation of Mesoporous Silica)

To a reaction vessel containing 30 g of water and 120 g of hydrochloric acid (2 M) was added 4.0 g of Plutonic P123 (manufactured by BASF) for dissolution, and the solution was heated to 35° C. To this solution was added 8.5 g of tetraethoxysilane, and the mixture was stirred at 35° C. for 20 hours, and then, at 80° C. for 10 hours. The reaction solution was cooled to room temperature, and filtered to obtain white particles. The resulting white particles were washed 3 times with water, dried at 100° C., and calcined at 500° C. for 6 hours to produce mesoporous silica. The peak in the pore diameter distribution curve measured by BJH method was at 6 nm, and the specific surface area measured by BET method was 900 m²/g. Regular mesoporous structure was observed in X-ray diffraction analysis.

(Formation of Silica Filled with Tin Oxide)

A solution prepared by mixing SnCl₄ and water at a rate of 3.5 g of water to 5.2 g of SnCl₄ was added dropwise to 500 mg of the thus formed mesoporous silica until the solution fully penetrated into the pores of the mesoporous silica to thereby fill the pores of the mesoporous silica with the tin oxide precursor. The mesoporous silica particles having the tin oxide precursor filled therein was added to 10 mL of 20% aqueous ammonia, and after stirring for 10 minutes and allowing the reaction solution to stand, the supernatant was decanted. Decantation by adding 10 mL of water and removing the supernatant was repeated 3 times. The particles were dried at 100° C., and calcined in a calcining furnace at 500° C. for 6 hours. The tin oxide used in this Example and the following Examples was SnO₂.

(Formation of Mesoporous Tin Oxide)

A NaOH aqueous solution (2N) was added to the mesoporous silica particles having the tin oxide filled therein produced by the calcination, and after stirring the mixture for 2 hours, the supernatant was decanted. Decantation by adding 10 mL of water and removing the supernatant was repeated 3 times, and the particles were dried at 100° C. The thus obtained mesoporous tin oxide was evaluated for its specific surface area, and the specific surface area determined by BET method using N₂ gas adsorption was 220 m²/g. Crystallite diameter calculated by Scherrer equation from diffraction peaks of [110] and [101] faces in X-ray diffraction analysis was 1.5 nm. The crystallite diameter calculated by Scherrer equation from diffraction peaks of [110] and [101] faces in X-ray diffraction analysis of the resulting mesoporous tin oxide particles after heating the particles to 700° C. for 3 hours was 1.5 nm, with no substantial difference in the crystallite diameter.

The resulting mesoporous tin oxide particles were dispersed in water, and centrifuged at 20,000 rpm for 1 hour. After removing the supernatant by filtration, the particles were dried and evaluated for their specific surface area. The specific surface area was 218 m²/g.

### COMPARATIVE EXAMPLE 1

(Formation of Mesoporous Silica)

Mesoporous silica was produced by repeating the procedure of Example 1.

(Formation of Silica Filled with Tin Oxide)

The mesoporous silica was filled with the tin oxide precursor by repeating the procedure of Example 1. The mesoporous silica particles having the tin oxide precursor filled therein were allowed to stand at room temperature for 24 hours in ammonia gas atmosphere, and then, calcined in a calcining furnace at 500° C. for 6 hours.

(Formation of Mesoporous Tin Oxide)

The silica part was dissolved by repeating the procedure of Example 1 to produce mesoporous tin oxide. Specific surface area of the thus obtained mesoporous tin oxide was 161 m²/g, and the crystallite diameter calculated by Scherrer equation from diffraction peaks of the tin oxide in X-ray diffraction analysis was 5.2 nm. In other words, the product had a smaller specific surface area and a larger crystallite diameter compared to Example 1.

The crystallite diameter calculated by Scherrer equation from diffraction peaks of [110] and [101] faces in X-ray diffraction analysis of the resulting mesoporous tin oxide particles after heating the particles to 700° C. for 3 hours was 9.2 nm, and the percent of change in the crystallite diameter was 77%.

The resulting mesoporous tin oxide particles were dispersed in water, and centrifuged at 20,000 rpm for 1 hour. After removing the supernatant by filtration, the particles were dried and evaluated for their specific surface area. The specific surface area was 110 m²/g, and the structural stability of the nanoporous structure was inferior to those of Example 1.

### COMPARATIVE EXAMPLE 2

(Formation of Porous Silica)

To 10 mL of HCl having polyethylene glycol having a molecular weight of 2×10⁴ dissolved therein was added 5 g tetraethoxysilane, and the mixture was stirred. 10 mL of 0.1M trishydroxymethylamine was added to this solution while cooling the solution in an ice bath. The solution was transferred to a petri dish, and allowed to stand in a wet atmosphere at 30° C. for 24 hours, and then dried at room temperature, and calcined at 500° C. for 5 hours to produce the porous silica. The thus obtained porous silica was evaluated by BJH method, and the peak in the pore diameter distribution curve was at 500 nm.

(Formation of Silica Filled with Tin Oxide)

The porous silica was filled the tin oxide by repeating the procedure of Example 1.

(Formation of Mesoporous Tin Oxide)

A NaOH aqueous solution (2N) was added to the porous silica particles having the tin oxide filled therein produced by the calcination, and after stirring the mixture for 2 hours, the supernatant was decanted. Decantation by adding 10 mL of water and removing the supernatant was repeated 3 times, and the particles were dried at 100° C. The thus obtained mesoporous tin oxide was evaluated for its specific surface area, and the specific surface area determined by BET method using N₂ gas adsorption was 65 m²/g. Crystallite diameter calculated by Scherrer equation from diffraction peaks of [110] and [101] faces in X-ray diffraction analysis was 11 nm. In other words, the product had a smaller specific surface area and a larger crystallite diameter compared to Example 1.

The crystallite diameter calculated by Scherrer equation from diffraction peaks of [110] and [101] faces in X-ray diffraction analysis of the resulting porous tin oxide particles after heating the particles to 700° C. for 3 hours was 11 nm, with no substantial difference in the crystallite diameter.

The resulting porous tin oxide particles were dispersed in water, and centrifuged at 20,000 rpm for 1 hour. After removing the supernatant by filtration, the particles were dried and evaluated for their specific surface area. The specific surface area was 63 m²/g, and no significant change in the specific surface area was noted due to the absence of the mesopores.

### COMPARATIVE EXAMPLE 3

(Formation of Tin Oxide Particles)

5 mL of the solution prepared by mixing SnCl₄ and water at a rate of 3.5 g of water to 5.2 g of SnCl₄ was added dropwise to 50 mL of 20% aqueous ammonia. After stirring for 10 minutes, the mixture was allowed to stand, and the supernatant was decanted. Decantation by adding 50 mL of water and removing the supernatant was repeated 3 times, and the particles were dried at 100° C., and then calcined in a calcining furnace at 500° C. for 6 hours. The thus obtained tin oxide was evaluated for its specific surface area, and the specific surface area determined by BET method using N₂ gas adsorption was 25 m²/g. Crystallite diameter calculated by Scherrer equation from diffraction peaks of [110] and [101] faces in X-ray diffraction analysis was 20 nm. In other words, the product had a smaller specific surface area and a larger crystallite diameter compared to Example 1.

The crystallite diameter calculated by Scherrer equation from diffraction peaks of [110] and [101] faces in X-ray diffraction analysis of the resulting tin oxide particles after heating the particles to 700° C. for 3 hours was 20 nm, with no substantial difference in the crystallite diameter.

The resulting tin oxide particles were dispersed in water, and centrifuged at 20,000 rpm for 1 hour. After removing the supernatant by filtration, the particles were dried and evaluated for their specific surface area. The specific surface area was 25 m²/g, and no significant change in the specific surface area was noted due to the absence of the mesopores.

### COMPARATIVE EXAMPLE 4

(Formation of Tin Oxide Particles)

10 mL of 20% aqueous ammonia was added to a solution prepared by dissolving 3 g of SnCl₄ in 200 mL of water. After stirring for 10 minutes, the mixture was allowed to stand, and the supernatant was decanted. Decantation by adding 10 mL of water and removing the supernatant was repeated 3 times, and the particles were dried at 100° C., and then calcined in a calcining furnace at 500° C. for 6 hours. The thus obtained tin oxide was evaluated for its specific surface area, and the specific surface area determined by BET method using N₂ gas adsorption was 38 m²/g. Crystallite diameter calculated by Scherrer equation from diffraction peaks of [110] and [101] faces in X-ray diffraction analysis was 10 nm. In other words, the product had a smaller specific surface area and a larger crystallite diameter compared to Example 1.

The crystallite diameter calculated by Scherrer equation from diffraction peaks of [110] and [101] faces in X-ray diffraction analysis of the resulting mesoporous tin oxide particles after heating the particles to 500° C. for 5 hours was 10 nm, with no substantial difference in the crystallite diameter.

### EXAMPLE 2

(Formation of Mesoporous Silica)

Mesoporous silica was produced by repeating the procedure of Example 1.

(Formation of Silica Filled with Tungsten Oxide)

A solution by mixing tungsten chloride, ethanol, and water at a rate of 7.2 g of tungsten chloride, 3.0 g of ethanol, and 0.5 g of water was added dropwise to 500 mg of the mesoporous silica produced by repeating the procedure of Example 1 until the solution fully penetrated into the pores of the mesoporous silica to thereby impregnate the pores of the mesoporous silica with the tungsten oxide precursor. The filled mesoporous silica was subsequently subjected to the hydrolysis and calcination by repeating the procedure of Example 1.

(Formation of Mesoporous Tungsten Oxide)

The silica part was dissolved by repeating the procedure of Example 1 to produce mesoporous tungsten oxide. Specific surface area of the thus obtained mesoporous tungsten oxide was 180 m²/g. Crystallite diameter calculated by Scherrer equation from diffraction peaks in X-ray diffraction analysis was 1.8 nm.

The crystallite diameter calculated by Scherrer equation from diffraction peaks in X-ray diffraction analysis of the resulting mesoporous tungsten oxide particles after heating the particles to 700° C. for 3 hours was 1.9 nm, with no substantial difference in the crystallite diameter.

The resulting mesoporous tungsten oxide particles were dispersed in water, and centrifuged at 20,000 rpm for 1 hour. After removing the supernatant by filtration, the particles were dried and evaluated for their specific surface area. The specific surface area was 175 m²/g.

### COMPARATIVE EXAMPLE 5

(Formation of Tungsten Oxide Particles)

10 mL of 20% aqueous ammonia was added to a solution prepared by dissolving 3 g of tungsten chloride in 200 mL of water. After stirring for 10 minutes, the mixture was allowed to stand, and the supernatant was decanted. Decantation by adding 10 mL of water and removing the supernatant was repeated 3 times, and the particles were dried at 100° C., and then calcined in a calcining furnace at 500° C. for 6 hours. The thus obtained mesoporous tungsten oxide was evaluated for its specific surface area, and the specific surface area was 20 m²/g. Crystallite diameter calculated by Scherrer equation from diffraction peaks in X-ray diffraction analysis was 18 nm. In other words, the product had a smaller specific surface area and a larger crystallite diameter compared to Example 2.

The crystallite diameter calculated by Scherrer equation from diffraction peaks in X-ray diffraction analysis of the resulting mesoporous tungsten oxide particles after heating the particles to 700° C. for 3 hours was 20 nm, and the percent of change in the crystallite diameter was 11%.

Examples 1 and 2 and Comparative Examples 1 to 5 are compared in Table 1 below.

| | Ex. 1 | C.E. 1 | C.E. 2 | C.E. 3 | C.E. 4 | E. 2 | C.E. 5 |
|---|---|---|---|---|---|---|---|
| Metal oxide formed | SnO₂ | SnO₂ | SnO₂ | SnO₂ | SnO₂ | WO₃ | WO₃ |
| Concentration (%) of the | 20 | NH₃ | 20 | 20 | 0.95 | 20 | 0.95 |
| aqueous ammonia used in the | | gas | | | | | |
| reaction | | | | | | | |
| Pore diameter of template | 6 | 6 | 500 | — | — | 6 | — |
| used (nm) | | | | | | | |
| Specific surface area (m²/g) | 220 | 161 | 65 | 25 | 38 | 180 | 20 |
| (after treating with NaOH) | | | | | | | |
| Average crystallite | 1.5 | 5.2 | 11 | 20 | 10 | 1.8 | 18 |
| diameter (nm) (after | | | | | | | |
| treating with NaOH) | | | | | | | |
| Average crystallite | 1.5 | 9.2 | 11 | 20 | 10 | 1.9 | 20 |
| diameter (nm) (after | | | | | | | |
| treating at 700° C. for 5 | | | | | | | |
| hours) | | | | | | | |
| Specific surface area (m²/g) | 218 | 110 | 63 | 25 | — | 175 | — |
| (after treating at 20,000 rpm | | | | | | | |
| for 1 hour) | | | | | | | |

E.: Example,
C.E.: Comparative Example

### EXAMPLE 3

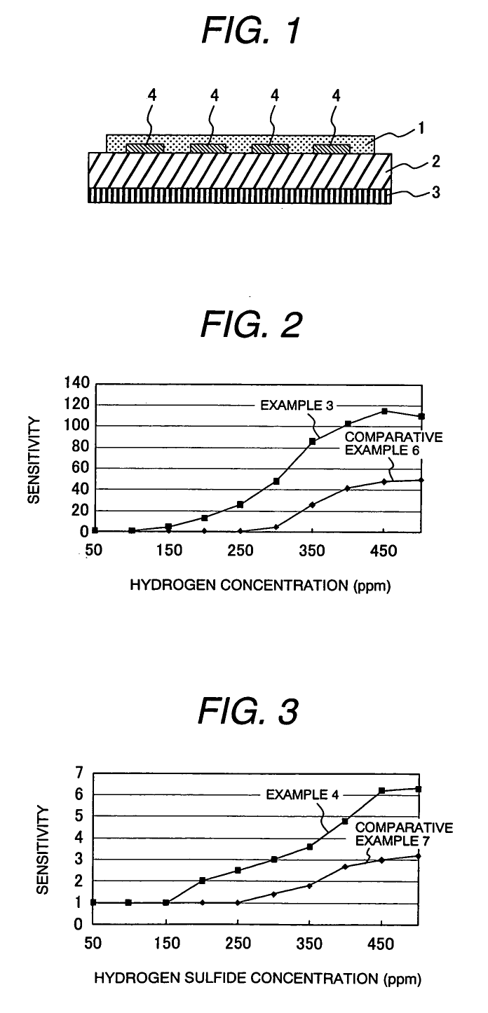

A solution prepared by mixing SnCl₄ and water at a rate of 3.5 g of water to 5.2 g of SnCl₄ was added dropwise to 500 mg of the thus formed mesoporous silica until the solution fully penetrated into the pores of the mesoporous silica to thereby fill the pores of the mesoporous silica with the tin oxide precursor and produce a paste of the mesoporous silica having its pores filled with the tin oxide precursor. The paste of the mesoporous silica filled with the tin oxide precursor was coated on an alumina substrate formed with a gold electrode pattern to form a membrane on the substrate. The substrate was immersed in 20% aqueous ammonia for 30 minutes, washed with water, dried at 100° C. to dry the particles, and calcined at 500° C. for 6 hours in a calcination furnace. The resulting membrane was immersed in aqueous solution of NaOH (2N), and after stirring for 4 hours, the supernatant was decanted. The membrane was further washed with water and dried at 100° C. to obtain a gas detector element having the structure as shown in FIG. 1.

### COMPARATIVE EXAMPLE 6

A paste of mesoporous silica filled with tin oxide precursor was produced by filling the mesoporous silica produced in Example 1 with a tin oxide precursor by repeating the procedure of Example 1. The paste of mesoporous silica filled with the tin oxide precursor was coated on an alumina substrate formed with a gold electrode pattern to form a membrane on the substrate. The substrate was placed in an ammonia gas atmosphere for 48 hours, washed with water, dried at 100° C. to dry the particles, and calcined at 500° C. for 6 hours in a calcination furnace. The resulting membrane was immersed in aqueous solution of NaOH (2N), and after stirring for 4 hours, washed with water and dried at 100° C. to obtain a gas detector element having the structure as shown in FIG. 1.

The gas detector element of FIG. 1 comprises an alumina substrate 2 which has a membrane 1 formed from mesoporous tin oxide particle and metal electrodes 4 on one side, and a heater substrate 3 on the other side. Resistance of the gas detector element was measured both in the atmosphere comprising nitrogen (79%) and oxygen (21%) and in the atmosphere comprising nitrogen (79%), oxygen (21%), and hydrogen (1-500 ppm). FIG. 2 shows the relationship between the temperature and the sensitivity. The gas detector element produced by using the mesoporous particles produced in Example 3 had a sensitivity higher than that of the gas detector element produced by using the mesoporous particles produced in Comparative Example 6. Also, the gas detector element produced by using the product of Example 3 could detect the change in the resistance at a temperature of up to 250° C. that could not be detected by the gas detector element produced by using the product of Comparative Example 6, proving the excellent gas detection sensitivity. It is to be noted that the gas sensitivity is the resistance in the atmosphere comprising nitrogen (79%) and oxygen (21%) divided by the atmosphere comprising nitrogen (79%), oxygen (21%), and hydrogen (1-500 ppm).

### EXAMPLE 4

A solution prepared by mixing tungsten chloride, ethanol, and water at a rate of 7.2 g of tungsten chloride, 3.2 g of ethanol, and 0.5 g of water was added dropwise to 500 mg of the mesoporous silica, and by using this paste, a gas detection element was produced by repeating the procedure of Example 3.

### COMPARATIVE EXAMPLE 7

A solution prepared by mixing tungsten chloride, ethanol, and water at a rate of 7.2 g of tungsten chloride, 3.2 g of ethanol, and 0.5 g of water was added dropwise to 500 mg of the mesoporous silica, and by using this paste, a gas detection element was produced by repeating the procedure of Example 7.

The gas detector elements produced in Example 4 and Comparative Example 7 were evaluated for their resistance in the atmosphere comprising nitrogen (79%) and oxygen (21%) and in the atmosphere comprising nitrogen (79%), oxygen (21%), and hydrogen (500 ppm). FIG. 3 shows the relationship between the temperature and the sensitivity. The gas detector element produced in Example 4 had a sensitivity higher than that of the gas detector element produced in Comparative Example 7. Also, the gas detector element produced in Example 4 could detect the change in the resistance at a temperature of up to 250° C. that could not be at all detected by the gas detector element produced in Comparative Example 7. It is to be noted that the gas sensitivity is the resistance in the atmosphere comprising nitrogen (79%) and oxygen (21%) divided by the resistance in the atmosphere comprising nitrogen (79%), oxygen (21%), and hydrogen sulfide (5 ppm).

### EXAMPLE 5

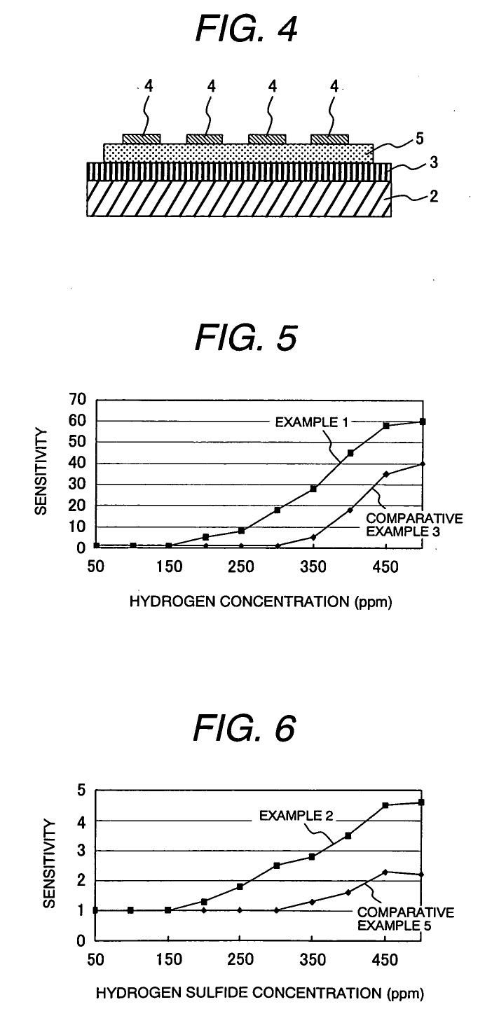

300 mg of the metal oxide crystals particles produced in Example 1 and Comparative Example 1 were respectively filled in a die extruder, and pressed in a mold at 400 kgf/cm² by applying pressure from both upper and lower sides of the mold to produce compacts in the shape of pellets having a diameter of 15 mm and a thickness of 3 mm. A gold electrodes pattern was formed on the metal oxide crystal compact by vacuum deposition. An alumina substrate and a ceramic heater were mounted under the metal oxide crystal compact to produce a gas detector element. The gas detector element produced is shown in FIG. 4. The gas detector element of FIG. 4 comprises a metal oxide crystal compact 5 which has a metal electrode 4 on its upper side and an alumina substrate 2 and a ceramic heater substrate 3 having a ceramic heater in its interior on the lower side. Resistance of the gas detector element was measured both in the atmosphere comprising nitrogen (79%) and oxygen (21%) and in the atmosphere comprising nitrogen (79%), oxygen (21%), and hydrogen (0 to 1000 ppm). FIG. 5 shows the relationship between the temperature and the sensitivity. The gas detector element produced by using the mesoporous particles produced in Example 1 had a sensitivity higher than that of the gas detector element produced by using the mesoporous particles produced in Comparative Example 1. Also, the gas detector element produced by using the product of Example 1 could detect the change in the resistance at a temperature of up to 300° C. that could not at all be detected by the gas detector element produced by using the product of Comparative Example 1. It is to be noted that the gas sensitivity is the resistance in the atmosphere comprising nitrogen (79%) and oxygen (21%) divided by the resistance in the atmosphere comprising nitrogen (79%), oxygen (21%), and hydrogen (500 ppm).

### EXAMPLE 6

The gas detector elements were produced from the metal oxide crystals particles produced in Example 2 and Comparative Example 5, respectively, by repeating the procedure of Example 5. The gas detector elements produced had the structure as shown in FIG. 4. Resistance of the gas detector element was measured both in the atmosphere comprising nitrogen (79%) and oxygen (21%) and in the atmosphere comprising nitrogen (79%), oxygen (21%), and hydrogen (0 to 1000 ppm). FIG. 6 shows the relationship between the temperature and the sensitivity. The gas detector element produced by using the mesoporous particles produced in Example 2 had a sensitivity higher than that of the gas detector element produced by using the mesoporous particles produced in Comparative Example 5. Also, the gas detector element produced by using the product of Example 2 could detect the change in the resistance at a temperature of up to 300° C. that could not at all be detected by the gas detector element produced by using the product of Comparative Example 5. It is to be noted that the gas sensitivity is the resistance in the atmosphere comprising nitrogen (79%) and oxygen (21%) divided by the resistance in the atmosphere comprising nitrogen (79%), oxygen (21%), and hydrogen (500 ppm).

### EXAMPLE 7

This Example is an embodiment wherein the catalyst support of the present invention is used in the hydrogen supplier in a hydrogen supplying system. Benzene and hexane, for example, are cyclic hydrocarbons containing the same number carbon atoms, and benzene is an unsaturated hydrocarbon in which carbon atoms are connected by double bond while cyclohexane is a saturated hydrocarbon having no double bond. Cyclohexane is generated by hydrogen addition to benzene, and benzene is obtained by dehydrogenation of cyclohexane. Storage and supply of hydrogen can be realized by using such addition and detachment of hydrogen to and from the hydrocarbon.

Such storage and supply of the hydrogen is generally accomplished by using a catalyst comprising catalyst particles of a precious metal such as platinum loaded on a catalyst support comprising an oxide. The support used for loading the catalyst is required to keep the precious metal catalyst in the state of fine particles, and should have a high surface area.

Next, an embodiment wherein the mesoporous oxide support of the present invention is applied to a hydrogen supplier is described. First, production of the catalyst is described.

(Formation of Mesoporous Silica)

To the reaction vessel containing 30 g of water and 120 g of hydrochloric acid (2M), 4.0 g of Pluronic P123 (manufactured by BASF) was dissolved, and the solution was heated to 35° C. 3.5 g of tetraethoxysilane was added, and the mixture was stirred at 35° C. for 20 hours, and then, at 80° C. for 10 hours. The reaction solution was cooled to room temperature, and white particles were obtained by filtration. The resulting white particles were washed with water for 3 times, dried at 100° C., and calcined at 500° C. for 6 hours to obtain mesoporous silica. The mesoporous silica had peak of the pore diameter distribution curve as measured by BJH method of 6 nm, a specific surface area as measured by BET method of 900 m²/g, and regular mesoporous structure was observed by X-ray diffraction analysis.

(Formation of Silica Filled Oxide)

A solution of ZrO₂ in a metal alkoxide was added dropwise to 500 mg of the thus formed mesoporous silica until the solution fully penetrated into the pores of the mesoporous silica to thereby fill the pores of the mesoporous silica with the ZrO₂ precursor. The mesoporous silica particles having the oxide precursor filled therein was added to 10 mL of 20% aqueous ammonia, and after stirring for 10 minutes and allowing the reaction solution to stand, the supernatant was decanted. Decantation by adding 10 mL of water and removing the supernatant was repeated 3 times. The particles were dried at 100° C., and calcined in a calcining furnace at 500° C. for 6 hours.

(Formation of Mesoporous Oxide)

NaOH aqueous solution (2N) was added to the mesoporous silica particle filled with ZrO₂ produced by the calcination, and after stirring for 2 hours, the supernatant was decanted. Decantation by adding 10 mL of water and removing the supernatant was repeated 3 times. The particles were dried at 100° C. to produce porous ZrO₂.

(Preparation of Catalyst)

The thus produced porous ZrO₂ was impregnated with 5% by weight platinum colloid manufactured by Tanaka Kikinzoku Kogyo, and the particles were heated at 450° C. to produce 10% Pt/porous ZrO₂ catalyst.

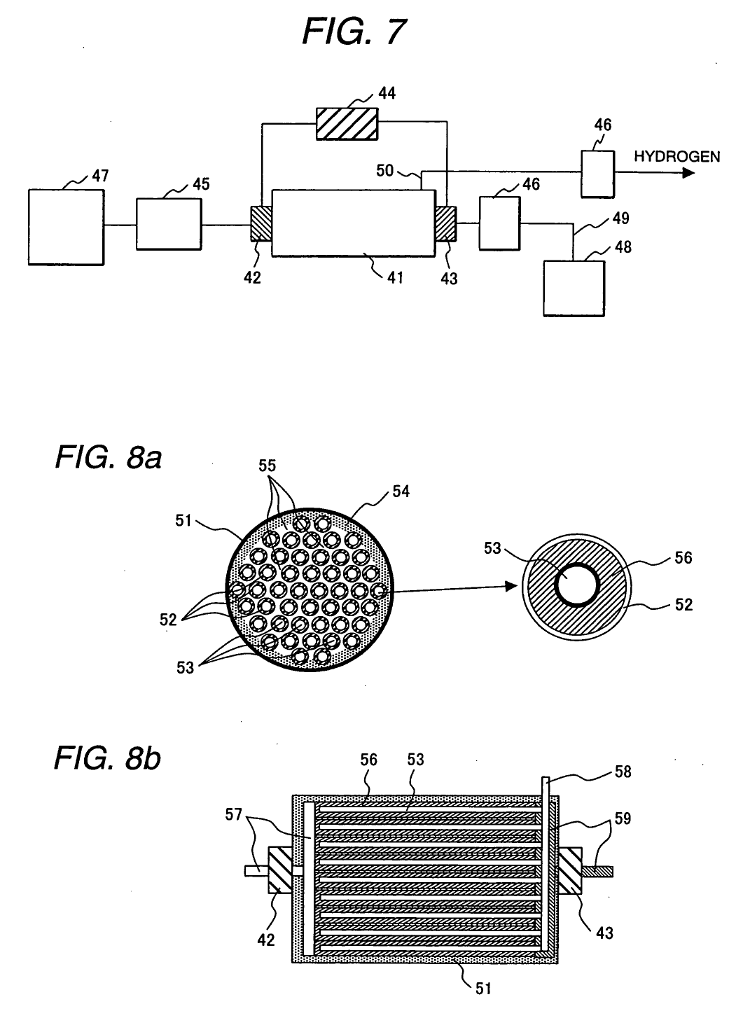

Next, the hydrogen supply system is described. The hydrogen supplier used in the hydrogen supply system may comprise a hydrogen separation tube and a microreactor. FIG. 7 shows a block diagram of the system including the hydrogen separation tube, and FIGS. 8A and 8B show the constitution of the hydrogen supplier including the hydrogen separation tube. The hydrogen supplier of FIGS. 8A and 8B is a system wherein the hydrogen generated is separated by a hydrogen separation tube to thereby supply high purity hydrogen. The hydrogen supply system using the hydrogen separation tube comprises a hydrogen supplier 41, a fuel supply valve 42, an exhaust valve 43, a valve controller 44, a fuel supply pump 45, exhaust pumps 46, a fuel tank 47, a waste tank 48, a waste flow path 49, and a hydrogen flow path 50. While two exhaust pumps, namely, one for the discharge of the reaction gas and one for separation of the hydrogen are provided in this embodiment, the pump for discharging the reaction gas may be omitted since the reaction gas will be automatically discharged due to the higher pressure in the interior of the hydrogen supplier.

The hydrogen supplier 51 using the hydrogen separation tube comprises a cylindrical reaction tube 52, a catalyst layer 56, a hydrogen separation tube 53, an insulator 54, and a fuel gas flow path 55. The fuel is supplied to the catalyst layer 56 from the fuel flow path 57. The hydrogen generated by the reaction is drawn by the exhaust pump 46, and penetrates into the hydrogen separation tube 53 kept at a lower pressure. The hydrogen is then transferred through a hydrogen collection tube 58 into the exhaust pump 46. The dehydrogenated fuel is transferred through the waste flow path 59 into the waste tank 48 for storage.

The catalyst layer may be heated by providing a heater along the outer periphery of the hydrogen supplier. However, the catalyst layer is typically heated by providing a burner (not shown) in the exterior of the hydrogen supplier, and a part of the waste mixed with the air is burned in a burner so that the resulting gas at a high temperature can be supplied to a fuel gas flow path 55 defined as a space between the reaction tubes 52 to thereby heat the reaction tube 52 and the catalyst layer 56.

Hydrogen was supplied from methylcyclohexane by using the hydrogen supply system as described above. In the hydrogen supply system, the hydrogen supplier was constituted from 20 hydrogen suppliers of the type shown in FIG. 8 connected in parallel with each other.

Next, an embodiment wherein a microreactor using a hydrogen separation membrane is used for the hydrogen supplier of the hydrogen supply system is described. The constitution of the hydrogen supply system was the same as that of FIG. 7.

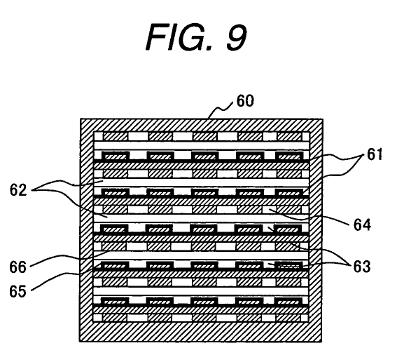

The hydrogen supplier 60 using a microreactor was constituted by stacking catalyst plates 61 and hydrogen separation membranes 62 one on another and mutually bonding them by frictional stirring as shown in FIG. 9. In the interior of the microreactor, spaces formed by etching function as fuel flow paths 63 and hydrogen flow paths 64. In stacking the catalyst plates and the hydrogen separation membranes, the hydrogen separation membrane 62 was placed between catalyst layer 65 of the catalyst plate and metal surface 66 of the adjacent catalyst plate. The fuel passes through the fuel flow path 63 to become in contact with the catalyst layer 65 and generate hydrogen. The thus generated hydrogen is separated through the hydrogen separation membrane 62 into the hydrogen flow path 64, and though this hydrogen flow path 64, the hydrogen is supplied to an exterior exhaust pump, fuel cell, or hydrogen engine.

The catalyst layer may be heated by providing a heater along the outer periphery of the hydrogen supplier. However, the catalyst layer is typically heated by providing a burner (not shown) in the exterior of the hydrogen supplier, and a part of the waste mixed with the air is burned in a burner so that the resulting gas at a high temperature can be supplied along exterior surface of the microreactor. The microreactor of FIG. 7 is typically used by arranging the microreactors in 4 lines and 8 columns. A heater is provided in the space between the microreactors or a combusted gas is supplied into such space. The outer periphery of the 4×3 microreactor assembly is protected by a thermal insulator.

Next, the microreactor is described.

A pure aluminum plate having a thickness of 1 mm (thermal conductivity, 250 W/mK) was used as a plate having a high thermal conductivity, and this plate was formed with a flow path pattern by photolithographic etching. On the other hand, a slurry was prepared by adding a predetermined amount of water to the 10% Pt/porous ZrO₂ catalyst which is used for the catalyst. This slurry was coated on the alumina substrate having the flow path pattern formed therewith, and the plate was dried to produce a catalyst plate.

Next, the thus produced catalyst plates and Pd—Ag hydrogen separation membranes were stack one on another and mutually bonded by friction stirring, and pipings were connected to produce a hydrogen supplier. The thus prepared hydrogen separation tube and the hydrogen supply system using the microreactor were used for supplying hydrogen from methylcyclohexane. As a consequence, a hydrogen gas flow rate of 250 L/min at 250° C. was achieved in both of the hydrogen separation tube and the microreactor. Supply of the hydrogen at a high rate with no decline in the performance is enable by the use of the porous ZrO₂ for the catalyst support which maintains the platinum in the state of microparticles.

Equivalent results were realized in the case other than ZrO₂ when CeO₂, WO₃, and Nb₂O₅ were used with the hydrogen supplier as in the case of ZrO₂.

What is claimed is:

1. A mesoporous metal oxide material comprising metal oxide crystals, wherein the metal oxide crystals have an average crystallite size of not less than 1 nm and not more than 2 nm and a crystallite diameter change rate of not more than 10% when the particles are heated at 700° C. for 3 hours.

2. The mesoporous metal oxide material according to claim 1 wherein the metal oxide is tin oxide.

3. The mesoporous metal oxide material according to claim 1 wherein the metal oxide comprises at least one member selected from niobium oxide, zirconium oxide, cerium oxide, and tungsten oxide.

4. A metal oxide material comprising metal oxide crystals having an average crystallite size of not less than 1 nm and not more than 2 nm and a crystallite diameter change rate of not more than 10% when the particles are heated at 700° C. for 3 hours.

5. The metal oxide material according to claim 4 wherein the metal oxide is tin oxide.

6. The metal oxide material according to claim 4 wherein the metal oxide comprises at least one member selected from niobium oxide, zirconium oxide, cerium oxide, and tungsten oxide.

7. A method for producing a mesoporous metal oxide material comprising the steps of:
filling a metal oxide precursor solution in pores of mesoporous template particles to form metal oxide precursor filling particles;
immersing the metal oxide precursor particles in an aqueous solution for hydrolysis to thereby hydrolyze the metal oxide precursor in the pores; and
subsequently dissolving the template part with an aqueous solution of NaOH or HF to thereby produce a mesoporous metal oxide material, which comprises metal oxide crystals having an average crystallite size of not less than 1 nm and not more than 2 nm and a crystallite diameter change rate of not more than 10% when the particles are heated at 700° C. for 3 hours.

8. A method for producing a metal oxide material comprising the steps of:
filling a metal oxide precursor solution in pores of mesoporous template particles to form metal oxide precursor filling particles; and immersing the metal oxide precursor filling particles in an aqueous solution for hydrolysis to thereby hydrolyze the metal oxide precursor in the pores, so as to produce the metal oxide material comprising metal oxide crystals having an average crystallite size of not less than 1 nm and not more than 2 nm and a crystallite diameter change rate of not more than 10% when the particles are heated at 700° C. for 3 hours.

9. A gas detector element comprising the mesoporous material of claim 1.

10. A gas element detector element comprising the metal oxide material of claim 4.

11. A method for producing a gas detector element comprising the steps of:
forming metal oxide precursor filling particles by filling pores of a mesoporous template with a metal oxide precursor solution;
forming a membrane filled with the metal oxide precursor filling particles by coating;
then, immersing the membrane filled with the metal oxide precursor filling particles in a hydrolysis aqueous solution;
forming a large number of metal oxide crystallites in the pores by accelerating hydrolysis decomposition reaction of the metal oxide precursor in the pores; and
thereafter, forming a gas detecting section of the membrane of mesoporous metal oxide particles or metal oxide particles by eluting the template with a NaOH aqueous solution or a HF aqueous solution.

12. A method for producing a thin membrane comprising the steps of filling a metal oxide precursor solution in pores of mesoporous template to form particles having the metal oxide precursor filled therein; forming a membrane of the particles having the metal oxide precursor filled therein by coating; and immersing the membrane of the particles having the metal oxide precursor filled therein in an aqueous solution for hydrolysis to thereby promote hydrolysis of the metal oxide precursor in the pores and produce a large number of metal oxide crystals in the pores.

13. A method for producing a gas detector element comprising the steps of filling a metal oxide precursor solution in pores of mesoporous template to form particles having the metal oxide precursor filled therein; forming a membrane of the particles having the metal oxide precursor filled therein by coating; and immersing the membrane of the particles having the metal oxide precursor filled therein in an aqueous solution for hydrolysis to thereby promote hydrolysis of the metal oxide precursor in the pores and produce a large number of metal oxide crystals in the pores; wherein gas detecting section of the gas detector comprises the membrane.

14. A hydrogen storage and supply system wherein the system uses an organic compound which undergoes repeated chemical cycles of hydrogen storage and release as its medium and wherein the release or the storage of the hydrogen is conducted in the presence of a catalyst on a support, and wherein the support is formed from particles comprising metal oxide crystals comprising at least one member selected from niobium oxide, zirconium oxide, cerium oxide, and tungsten oxide, which have an average crystallite size of not less than 1 nm and not more than 2 nm and a crystallite diameter change rate of not more than 10% when the particles are heated at 700° C. for 3 hours.

15. The hydrogen storage and supply system according to claim 14 wherein the hydrogen storage and supply system comprises
a substrate having a high thermal conductivity;
a plurality of flowpaths for said medium formed on at least one surface of the substrate;
a catalyst layer formed in said flow paths;
a hydrogen separation means for separating the hydrogen formed, the medium storing the hydrogen, and the medium after releasing the hydrogen;
a port for each of the hydrogen formed, the medium storing the hydrogen, and the medium after releasing the hydrogen, which have been separated by the hydrogen separation means.
